(19) United States
(12) Patent Application Publication
(10) Pub. No.: US 2022/0216823 A1
(43) Pub. Date: Jul. 7, 2022

(54) FIXED STRUCTURE OF SOLAR PANELS AND C-SHAPED STEEL

(71) Applicants: Chen Lu WANG, Douliu City (TW); Chao Kai WANG, Douliu City (TW)

(72) Inventors: Chen Lu WANG, Douliu City (TW); Chao Kai WANG, Douliu City (TW)

(21) Appl. No.: 17/142,832

(22) Filed: Jan. 6, 2021

(51) Int. Cl. H02S 30/10; F16B 5/06; F16B 5/12

(52) U.S. Cl. CPC H02S 30/10; F16B 5/121; F16B 5/0685

(57) ABSTRACT

A fixed structure of solar panels and C-shaped steel includes a spacer disposed on a top surface of the C-shaped steel with two opposite sides each forming a positioning surface for solar panels abutting against so that solar panels are spaced apart and are positioned by the spacer. A fastening frame is disposed above the C-shaped steel while a pressing member is disposed under the C-shaped steel. The pressing member has a first end abutting against the C-shaped steel and a second end abutting against the solar panels. A bolt with a nut penetrates through the fastening frame and the pressing member. The pressing member, by locking the nut, abuts against the C-shaped steel and the solar panels so that the fastening frame and the C-shaped steel are in cooperation to clamp the solar panels for fastening.

### BACKGROUND OF THE INVENTION

### Technical Field

The present invention relates to a solar power generation device, and more particularly to an assembly structure for solar panels.

### Description of Related Art

Solar panels generate electricity by absorbing solar energy and therefore are put outdoors. Solar panels are fixed on support frames which are assembled at a pre-determined place. Conventional support frames for solar panels include an upper frame and a bottom frame. After the bottom frame is set, put solar panels on the bottom frame and then fix the upper frame with the bottom frame. Therefore, solar panels are clamped by the upper frame and the bottom frame.

Each of the upper frame and the bottom frame, however, is metal product with such high price that cost much if the amount is large.

### SUMMARY OF THE INVENTION

The primary objective of the present invention is to fix solar panels on C-shaped steels with a small number of components in order to lower cost.

For achieving the foregoing and other objectives, the present invention includes a C-shaped steel extending in a lateral direction and a fastening frame extending in a longitudinal direction, the fastening frame being above the C-shaped steel. A rubber strip for waterproofing is provided between the fastening frame and the solar panels. The C-shaped steel has a top surface for solar panels laying thereon. A spacer is disposed on the top surface with two opposite sides each being provided with a positioning surface for solar panels abutting against so that solar panels are spaced apart and are positioned by the spacer. A pressing member is disposed under the C-shaped steel with a first end abutting against the C-shaped steel and a second end abutting against the solar panels. A bolt penetrates through a first hole of the fastening frame and a second hole of the pressing member and then connects with a nut. By locking the nut, the pressing member abuts against the C-shaped steel and the solar panels so that the fastening frame and the C-shaped steel are in cooperation to clamp the solar panels for fastening.

Preferably, the spacer is made of a non-conductive material. The positioning surfaces are located on a middle portion of the spacer. The middle portion includes a gasket extending between the C-shaped steel and the solar panels.

Preferably, the fastening frame includes a groove extending in the longitudinal direction between the solar panels.

Preferably, the C-shaped steel includes a downward extending portion disposed at a side of the top surface. The downward extending portion is abutted by the first end of the pressing member.

Preferably, the first end of the pressing member is bent upward to hook the downward extending portion. The second end of the pressing member includes a flat portion which is totally engaged with the solar panels.

Preferably, the bolt includes a head portion which is larger than the first hole, a chin portion in a complementary shape to the first hole except for circle and a body portion with threads. The head portion abuts against the fastening frame. The chin portion inserts into the first hole. The body portion passes through the first hole and the second hole.

### BRIEF DESCRIPTION OF THE DRAWINGS

FIG. 1 is a perspective view of the present invention;

FIG. 2 is an exploded view of the present invention;

FIG. 3 is a top plane view of the present invention 3;

FIG. 4 is a sectional view in the plane A-A of FIG. 3;

FIG. 5 is a sectional view in the plane B-B of FIG. 3;

FIG. 6 is a sectional view in the part C of FIG. 1; and

FIG. 7 is an exploded view of the auxiliary fastening member of the present invention.

### DETAILED DESCRIPTION OF THE INVENTION

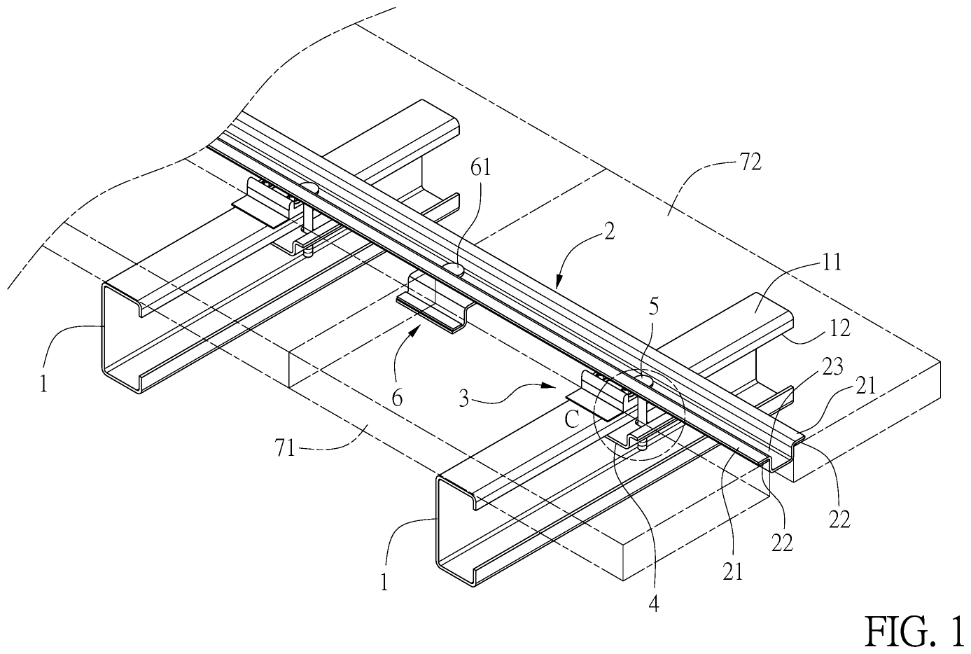

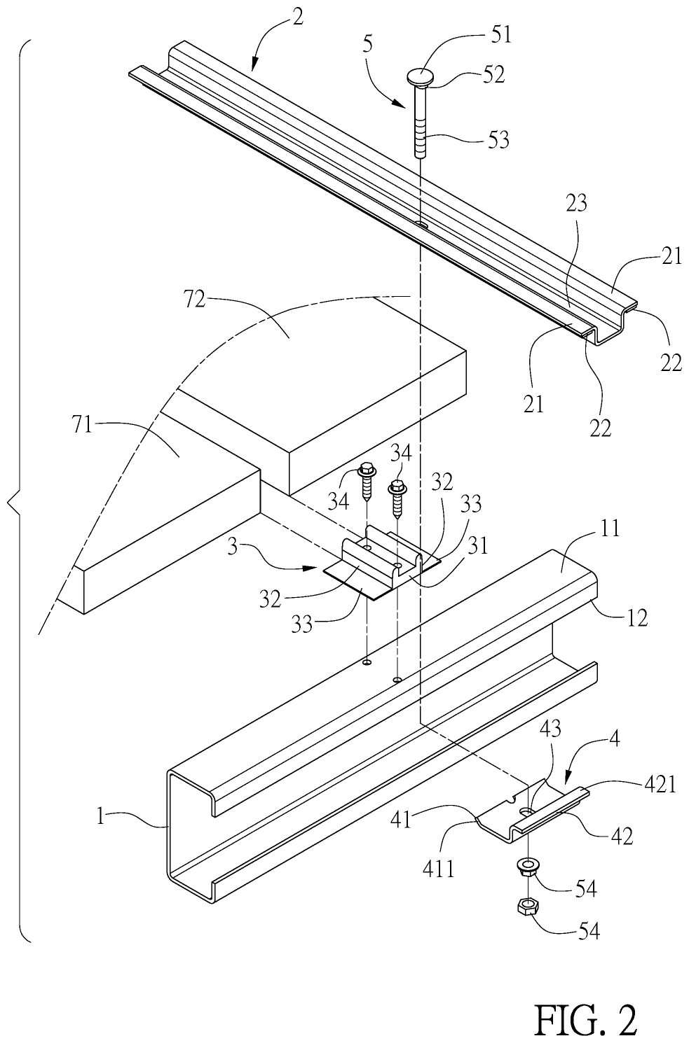

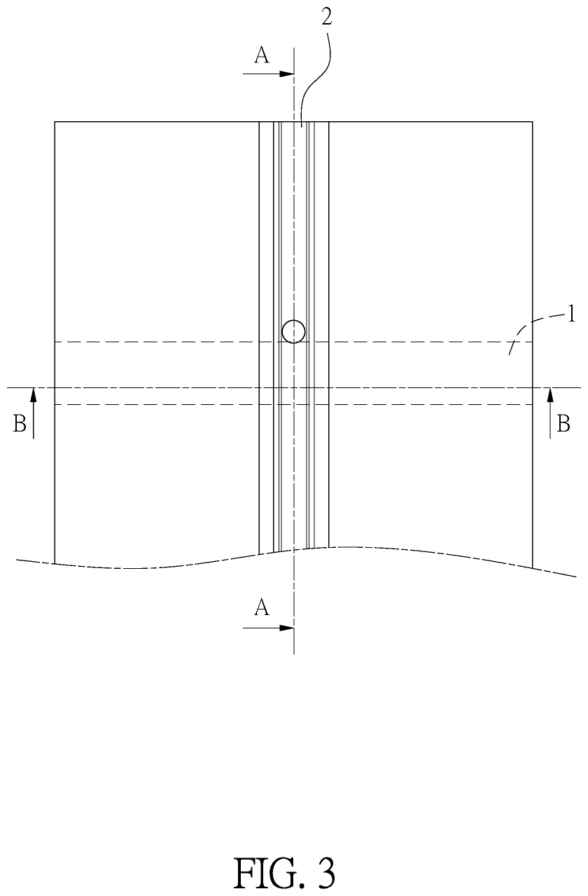

Referring to FIG. 1, FIG. 2 and FIG. 3, the present invention includes a C-shaped steel 1 extending in a lateral direction, a fastening frame 2 extending in a longitudinal direction and a pressing member 4. With the C-shaped steel 1 being a part of roof construction, cost of the present invention may be reduced.

A top surface 11 is provided on the C-shaped steel 1 and spacers 3 are arranged at intervals. Each of the spacers 3 is fixed on the C-shaped steel 1 by screws 34. Each of the spacers 3 is made of a non-conductive material and has a middle portion 31 with two opposite sides each provided with a positioning surface 32. Each of the two opposite sides of the middle portion 31 has a gasket 33.

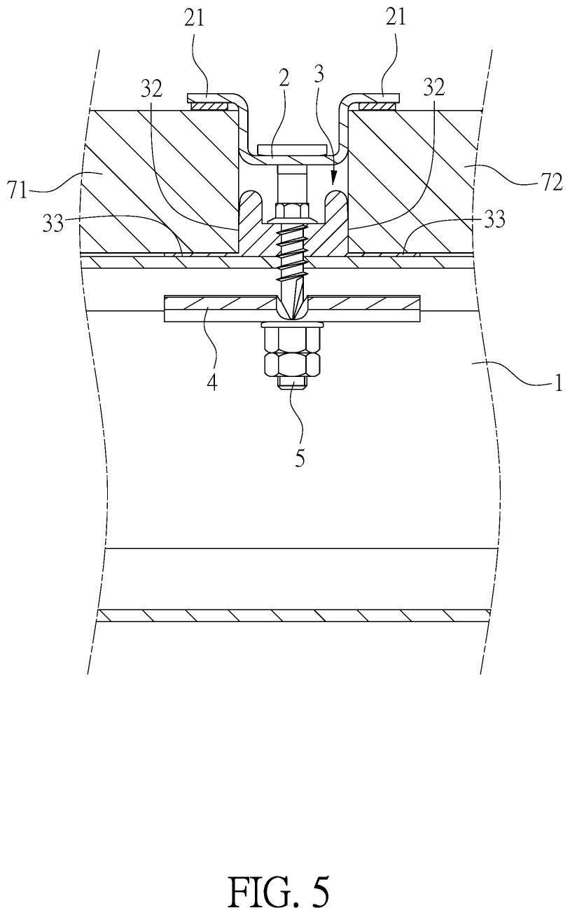

The spacer 3 is used to separate the solar panels 71, 72 arranged on the top surface 11 of the C-shaped steel 1. As shown in FIG. 5, one solar panel 71 is disposed at one side of the spacer 3 while another solar panel 72 is disposed at the opposite side. The solar panels 71, 72 laterally abut against the positioning surfaces 32 respectively. Bottom surfaces of the solar panels 71, 72 are separated from the C-shaped steel 1 by the gaskets 33.

The fastening frame 2 is located above the C-shaped steel 1 and is provided with two wing portions 21 pressing on the solar panels 71, 72. There are rubber strips 22 for waterproofing between the wing portions 21 and the solar panels 71, 72. In this embodiment, the fastening frame 2 includes a groove 23, extending in the longitudinal direction, located in the interval between the solar panels 71, 72 in order to guide the drainage of rainwater.

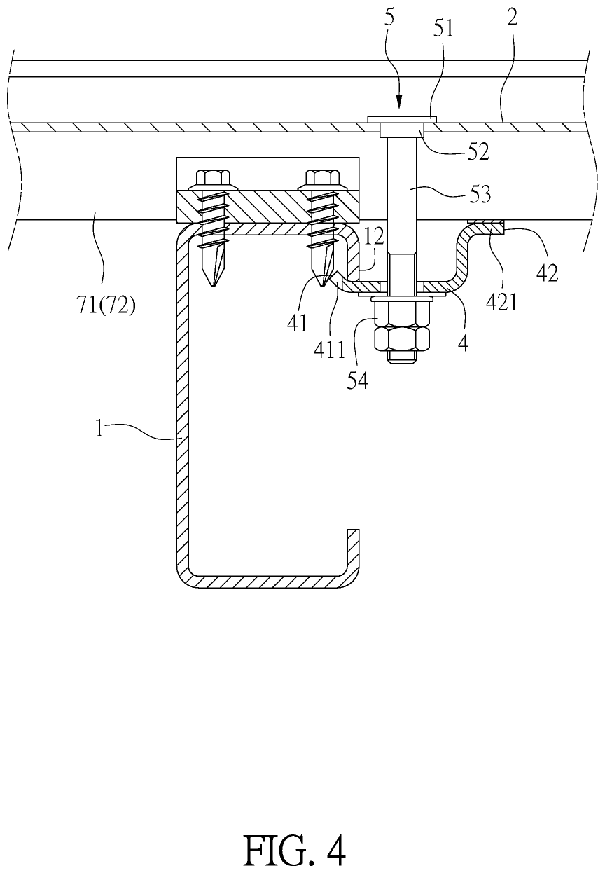

Referring to FIG. 4, the pressing member 4 is a bent plate having a lower first end 41 and a higher second end 42. The first end 41 is bent upward to form a hook portion 411 so as to hook a downward extending portion 12 disposed at a side of the top surface 11 of the C-shaped steel 1. The second end 42 includes a flat portion 421 which is totally engaged with the solar panels 71, 72.

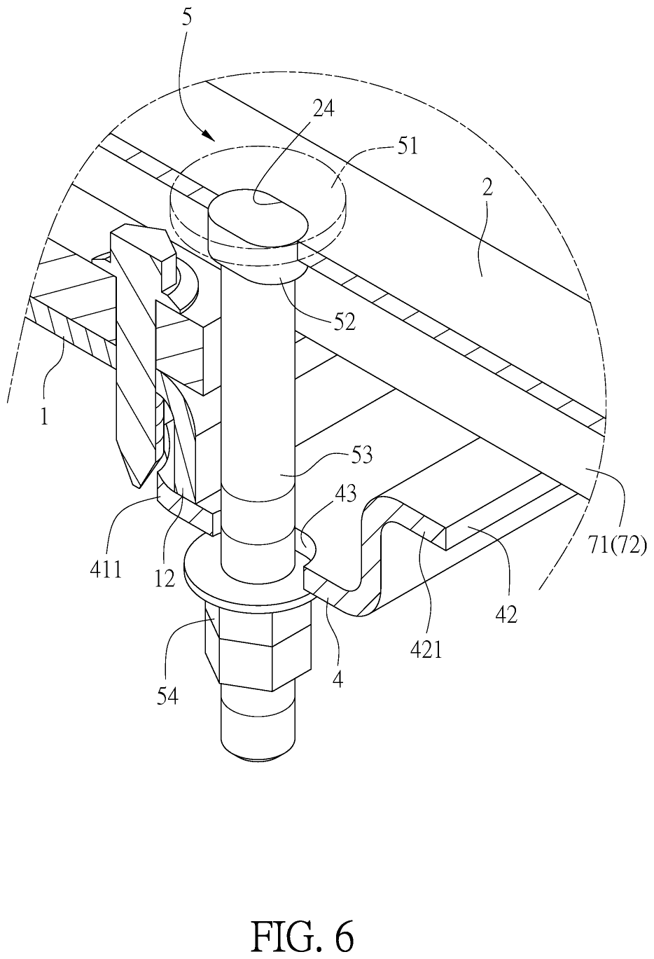

Referring to FIG. 6, a first hole 24 is provided on the fastening frame 2, and a second hole 43 is provided on the pressing member 4. A bolt 5 penetrates the fastening frame 2 and the pressing member 4 through the first hole 24 and the second hole 43, and then the bolt 5 connects with a nut 54. The bolt 5 includes a head portion 51, a chin portion 52 and a body portion 53 with threads. The head portion 51 has a greater diameter than that of the first hole 24 so as to abut against the fastening frame 2. The chin portion 52 inserts into the first hole 24. The body portion 53 passes through the first hole 24 and the second hole 43. After locking the nut 54, the pressing member 4 is forced to upwardly press on the C-shaped steel 1 and the solar panels 71, 72 while the fastening frame 2 is forced to downwardly press on the solar panels 71, 72. The solar panels 71, 72, therefore, are fixed.

The chin portion 52 is preferably in a complementary shape to the first hole 24 except for circle. In this embodiment, each of the chin portion 52 and the first hole 24 is elongated laterally so that the chin portion 52 is stopped from turning in the first hole 24. Hence, it is easy and quick to lock the nut 54 since the bolt 5 is never driven to turn in the course of locking the nut 54.

In the present invention, the pressing member 4 is used to fix the solar panels between the C-shaped steel 1 and the fastening frame 2. The present invention, therefore, facilitates simplification to the structure and reduction to the cost as a result of a small volume and a simple structure of the pressing member 4.

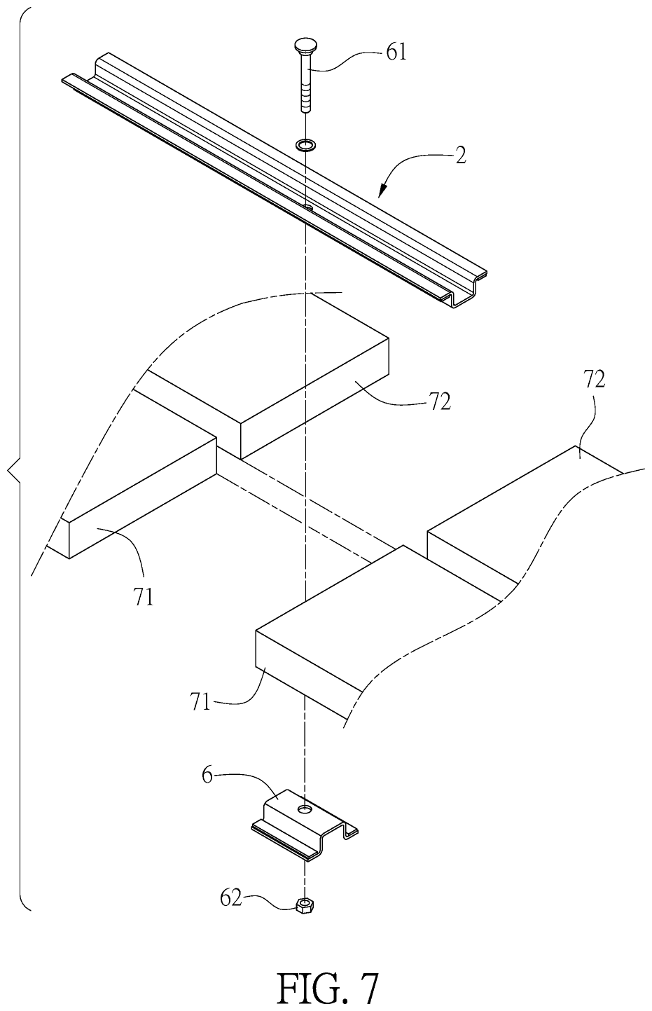

Moreover, as shown in FIG. 1 and FIG. 7, a reinforcing member 6 is provided at a junction of two solar panels between two C-shaped steels 1 to enhance the stability of the solar panels. The reinforcing member 6 is put under the fastening frame 2 and the solar panels 71, 72 while a bolt 61 penetrates the fastening frame 2 and the reinforcing member 6, and then the bolt 61 connects with a nut 62. After locking the nut 62, the fastening frame 2 and the reinforcing member 6 are forced to press on the solar panels 71, 72 to fix the solar panels 71, 72.

What is claimed is:

1. A fixed structure of solar panels and C-shaped steel comprising:
a C-shaped steel, extending in a lateral direction, having a top surface for solar panels laying thereon;
a spacer disposed on the top surface with two opposite sides each being provided with a positioning surface for solar panels abutting against so that solar panels are spaced apart and are positioned by the spacer;
a fastening frame, extending in a longitudinal direction, disposed above the C-shaped steel, the fastening frame including a bolt penetrated through a first hole which is provided on the fastening frame, wherein a rubber strip for waterproofing is provided between the fastening frame and the solar panels;
a pressing member disposed under the C-shaped steel with a first end abutting against the C-shaped steel and a second end abutting against the solar panels, wherein the bolt penetrates through a second hole of the pressing member and then connects with a nut, the pressing member, by locking the nut, abuts against the C-shaped steel and the solar panels so that the fastening frame and the C-shaped steel are in cooperation to clamp the solar panels for fastening.

2. The fixed structure of solar panels and C-shaped steel as claimed in claim 1, wherein the spacer is made of a non-conductive material; the positioning surfaces are located on a middle portion of the spacer, wherein the middle portion includes a gasket extending between the C-shaped steel and the solar panels.

3. The fixed structure of solar panels and C-shaped steel as claimed in claim 1, wherein the fastening frame includes a groove extending in the longitudinal direction between the solar panels.

4. The fixed structure of solar panels and C-shaped steel as claimed in claim 3, wherein the C-shaped steel includes a downward extending portion disposed at a side of the top surface, the downward extending portion being abutted by the first end of the pressing member.

5. The fixed structure of solar panels and C-shaped steel as claimed in claim 4, wherein the first end of the pressing member is bent upward to hook the downward extending portion.

6. The fixed structure of solar panels and C-shaped steel as claimed in claim 1, wherein the second end of the pressing member includes a flat portion which is totally engaged with the solar panels.

7. The fixed structure of solar panels and C-shaped steel as claimed in claim 1, wherein the bolt includes a head portion which is larger than the first hole, a chin portion in a complementary shape to the first hole except for circle and a body portion with threads, the head portion abutting against the fastening frame, the chin portion inserting into the first hole, the body portion passing through the first hole and the second hole.
